(19) United States
(12) Patent Application Publication
(10) Pub. No.: US 2004/0066039 A1
(43) Pub. Date: Apr. 8, 2004

(54) Mechanical tube to fitting connection

(76) Inventors: Anis Muhammad, Mississauga (CA); Thomas Seiler, Milton (CA); Alan Wu, Kitchener (CA); Eric Luvisotto, Mississauga (CA)

Correspondence Address: DYKEMA GOSSETT PLLC, 39577 WOODWARD AVENUE, SUITE 300, BLOOMFIELD HILLS, MI, 48304-5086, US

(21) Appl. No.: 10/264,768

(22) Filed: Oct. 4, 2002

(51) Int. Cl. F16L 13/14

(52) U.S. Cl. 285/382

(57) ABSTRACT

A mechanical connection for tubular members has a male tubular member with a distal end portion containing an O-ring. A female tubular member fits over the male member in sealing engagement with the O-ring, so that the O-ring is only radially compressed. The female member is crimped or compressed on to the male member, such that engaging ribs and grooves in the male and female members lock the members together against axial relative movement. The crimping operation does not affect the O-ring seal because the ribs and grooves are spaced axially from the O-ring seal.

This invention relates to fluid connectors or couplings, and in particular, to mechanical connections as opposed to joints made by heat processes such as soldering or brazing.

Mechanical fluid connections commonly involve a male conduit or tube that fits into a female component such as a fitting or an expanded portion of another tubular member. O-rings are commonly used between the components to give a fluid tight seal. However, the O-rings are not strong enough to hold the mating components together, so some other device must be used for this purpose.

The type of device used to hold the components together usually depends upon whether or not the connection or coupling is intended to be permanent or releasable. In a releasable connection, which is sometimes referred to as a quick connector, spring loaded pins or balls are often used to create interference between the components and prevent them from coming apart. A difficulty with these types of arrangements, however, is that they are complicated and difficult to assemble and consequently relatively expensive.

There are other types of couplings that can be connected and disconnected, but usually they involve a third member in addition to the male and female components, and this third member may be more or less permanently mounted in the coupling or attached to the male and female members to prevent them from separating. An example of such a coupling is shown in U.S. Pat. No. 6,267,416 issued to Luis Ferreira, et al. In this patent, a retainer with spring-loaded arms fits between the male and female components to prevent them from disengaging. A difficulty with these types of devices, however, is that the separate retainer element or member increases the complexity and cost of the coupling undesirably.

The present invention is a very simple coupling having a radially compressed seal to make it effectively fluid tight, wherein the female component is deformed to engage a circumferential annular shoulder on the male component and prevent separation of the connector.

According to one aspect of the invention, there is provided a mechanical tube connection comprising a male tubular member having a distal end portion defining a circumferential sealing member groove located therein. An annular sealing member is provided for location in the sealing member groove. A female member has a female tubular wall portion adapted to accommodate the male tubular member distal end portion with the annular sealing member in sealing engagement therebetween. One of the male tubular member and the female tubular wall portion has a circumferential shoulder formed therein spaced from the annular sealing member groove, so as not to compress axially the sealing member. The other of the male tubular member and the female tubular wall portion has a radially disposed protrusion adapted to bear against the shoulder to prevent separation of the male and female members.

According to another aspect of the invention, there is provided a method of making a connection between two telescoping tubular members. The method comprises the steps of providing a male tubular member with an annular seal located on the exterior thereof and an annular flange extending radially outwardly and being axially spaced from the annular seal. A female tubular member is slid over the male member, the female member having a first portion with an inside diameter dimensioned to be in sealing engagement with the sealing member and an adjacent second portion with an inside diameter dimensioned to slide over the male member annular flange. The second portion is compressed inwardly to engage the flange, thereby preventing relative axial movement between the male and female members.

According to yet another aspect of the invention, there is provided a method of making a connection between two telescoping tubular members. The method comprises the steps of providing a male tubular member with an annular sealing member located on the exterior thereof and an outwardly opening annular groove spaced from the annular sealing member. A female tubular member is slid over the male member, the female member having an inside diameter dimensioned to be in sealing engagement with the sealing member. The female member is inwardly deformed so that a portion of a female member enters the annular groove thereby preventing relative axial movement between the male and female members.

Preferred embodiments of the invention will now be described, by way of example, with reference to the accompanying drawings, in which:

FIG. 1 is a cross-sectional view of a distal end portion of a male tubular member according to one preferred embodiment of a connector according to the present invention;

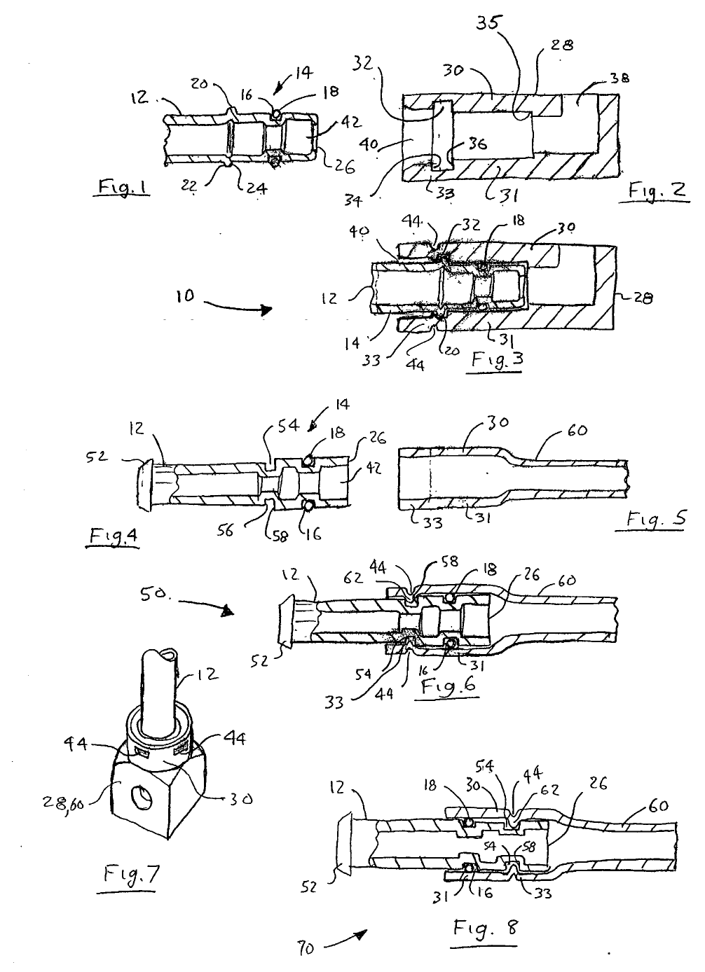

FIG. 2 is a cross-sectional view of a female member adapted to accommodate the male member of FIG. 1;

FIG. 3 is a cross-sectional view of the assembled connector made up of the components shown in FIGS. 1 and 2;

FIG. 4 is a partial sectional view of a distal end portion of a male tubular member of a connector according to another preferred embodiment of the present invention;

FIG. 5 is a cross-sectional view of a female member adapted to accommodate the male member of FIG. 4;

FIG. 6 is a cross-sectional view showing the assembled connector made up of the male and female components shown in FIGS. 4 and 5;

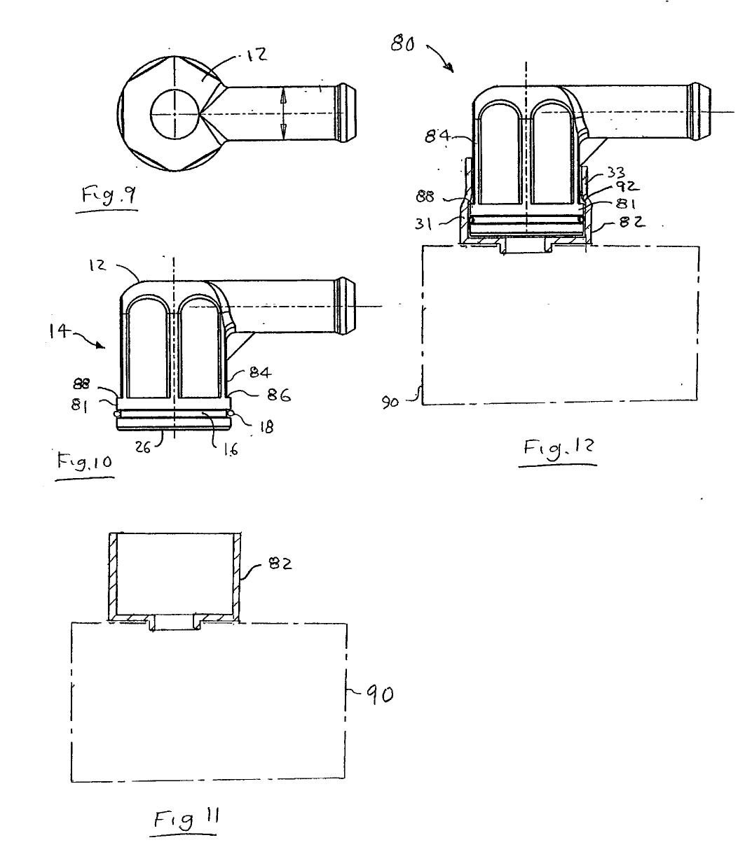

FIG. 7 is a perspective view of another preferred embodiment of a connector according to the present invention;

FIG. 8 is a cross-sectional view similar to FIG. 6, but showing another preferred embodiment of a connector according to the present invention;

FIG. 9 is a top view of a male component of yet another preferred embodiment of a connector according to the present invention;

FIG. 10 is an elevational view of the component shown in FIG. 9;

FIG. 11 is a cross-sectional view of a female member adapted to receive the male member shown in FIG. 10; and

FIG. 12 is a partial cross-sectional view of the assembled components shown in FIGS. 9 to 11.

In the preferred embodiments described below, like reference numerals are used in the various Figures to indicate parts or components that are similar in the various embodiments.

Referring firstly to FIGS. 1 to 3, a first preferred embodiment of a fluid connection or connector according to the present invention is generally indicated by reference numeral 10. Connection 10 includes a male tubular member 12 having a distal end portion 14 defining a circumferential sealing member groove 16 located or formed therein. An annular sealing member in the form of an O-ring is located in sealing member groove 16. Sealing member groove 16 is made by deforming distal end portion 14, but it could be machined into the wall of the tubular distal end portion if the wall thickness is sufficient for this purpose.

Distal end portion 14 also has an annular flange 20 formed by axially compressing and deforming the wall of distal end portion 14. Annular flange 20 has circumferential shoulders 22 and 24, the purpose of which will be described below. Distal end portion 14 has a distal end 26. Sealing member groove 16 and O-ring 18 are located adjacent to distal end 26 and annular flange 20 is located on the side of the annular sealing member groove 16 remote from distal end 26. However, the positions of sealing member groove 16 and annular flange 20 could be reversed, if desired.

Referring next to FIG. 2, the female member 28 of connection 10 has a female tubular wall portion 30 which is adapted to accommodate the male tubular member 12 or the male tubular member distal end portion 14. Tubular wall portion 30 has a first portion 31 with an inside diameter dimensioned to be in sealing engagement with the O-ring sealing member 18. First portion 31 and sealing member groove 16 are dimensioned according to the size of O-ring 18, so that the O-ring is compressed radially when distal end portion 14 enters the female member 28, thereby giving an appropriate fluid-tight seal depending upon the working pressure of connection 10. First portion 31 also has an annular seat 35 against which the annular male member distal end bears on the assembled connection 10, the purpose of which is discussed below.

Female member 28 has a second portion 33 with an inside diameter dimensioned to slide over the male member annular flange 20. Second portion 33 has an inside annular groove 32, and the peripheral sides 34 and 36 of groove 32 form circumferential shoulders to prevent separation of the male and female members 12 and 28 as discussed below. The inner edge of side 36 may be chamferred or curved to facilitate insertion.

Female member 28 is actually a fitting that can be attached to another fluid device, such as a heat exchanger, by brazing or soldering by any other attachment means. A fluid passage 38 communicates with an axial bore 40, which in turn accommodates and communicates with axial bore 42 of male tubular member 12.

Referring next to FIG. 3, the assembled connection or connector 10 is shown and it will be noted that the length of distal end portion matches the depth axial bore 40, with distal end 26 bearing against annular seat 35, so that annular flange 20 lines up with annular groove 32. However, distal end portion 14 could be shorter than bore 40. The inside diameter of shoulder 36 is smaller than the outside diameter of flange 20, flange 20 bears against shoulder 36 to locate flange 20 adjacent to groove 32. Bore 40 in the area of O-ring 18 has an axially straight inner wall surface, so it does not matter precisely where O-ring 18 is located. O-ring 18 is in radial compression only, as opposed to being axially or longitudinally compressed. When annular flange 20 is lined up with annular groove 32, the tubular wall portion 30 is swaged or deformed inwardly, forming depressions 44 causing the walls of annular groove 32 to close in and engage flange 20, so that shoulders 22 and 24 engage the annular groove sides or shoulders 34 and 36, thus preventing separation of male member 12 from female member 28. If the inward depression or swaging of wall portion 30 is sufficiently tight, it will provide a seal to prevent foreign matter getting inside connection 10, and also prevent relative rotation between male tubular member 12 and female member 28. A looser deformation of wall portion 30 will permit relative rotation between the male and female members 12, 28. A sealant or second sealing member could be located in groove 32 prior to the swaging operation to ensure a fluid-tight seal in this area. Depressions 44 could be continuous around the circumference of tubular member 30, or they could be intermittent or spaced apart and done by a staking operation, as indicated in FIG. 7. It will be appreciated that only one of these circumferential peripheral shoulders, namely the outward peripheral shoulder 34, is required to engage annular flange 20 to prevent the male tubular member 12 from coming out of the female member or fitting 28. It will also be appreciated that annular groove 32 and flange 20 are axially spaced from the annular sealing member groove 16 a sufficient distance so as not to compress axially or interfere with O-ring 18 when the depressions 44 are made in tubular wall portion 30.

Annular flange 20 is a radially disposed protrusion which is adapted to bear against the annular groove shoulders or circumferential shoulders 34 and 36, and in particulars shoulder 34, to prevent separation of the male and female members 12 and 28.

Referring next to FIGS. 4 to 6, another preferred embodiment of a connector or connection according to the present invention is generally indicated by reference numeral 50. Male tubular member 12 is shown having an enlarged tapered end portion 52, so that male member 12 becomes a hose barb for the attachment of a flexible hose in the usual manner if desired. However, this is optional. Tubular member 12 can be plain tube of any length desired. In male tubular member 12, the annular flange 20 of FIG. 1 has been replaced by an annular groove 54 formed on the outside surface of the annular tubular member 12. Annular groove 54 has peripheral side walls or circumferential shoulders 56, 58.

Female member 60 has an enlarged distal end portion or tubular wall portion 30 to accommodate the distal end portion 14 of male tubular member 12. When distal end portion 14 is located in tubular wall portion 30, the second wall portion 33 is inwardly swaged or deformed causing depressions 44, again, either continuously around the circumference or intermittent is shown in FIG. 7, thus forming a radially inwardly disposed protrusion 62 to engage the annular groove peripheral or circumferential shoulders 56 and 58 to prevent separation of male tubular member 12 from female member 60. Again, protrusions 62 can be a continuous radially inwardly disposed flange, or they could be intermittent or spaced apart inwardly disposed projections. Again, it is only necessary that protrusions 62 engage the inboard or inner circumferential shoulder 58 to prevent male tubular member 12 from coming out of female member 63. Again, a tight connection between protrusion 62 and groove 54 will provide a secondary fluid-tight seal in addition to O-ring 18, and also prevent relative rotation between the male and female tubular members 12 and 60. A looser connection therebetween would permit such relative rotation. A sealant or additional seal in groove 54 prior to the deformation of female member 60 would also provide a fluid-tight seal, even if the deformation was loose enough to permit relative rotation between the members.

FIG. 8 shows another connection or connector 70 that is similar to connector 50 of FIGS. 4 to 6. The difference between connector 50 and 70 is that in connector 50, the sealing member groove 16 is located adjacent to distal end 26 and annular or circumferential groove 54 is located on the side of the annular sealing member groove 16 remote from distal end 26. However, in connector 70 of FIG. 8, the circumferential shoulder 58 formed by annular groove 54 is located adjacent to distal end 26, and the sealing member groove 16 is located on the side of circumferential shoulder 58 remote from distal end 26. In some applications, the presence of the O-ring in groove 16 may prevent corrosion causing moisture from getting in the area between groove 16 and 54.

FIG. 7 illustrates that the female member 28 could be in a form of a fitting of any shape desired. The fitting 28 or 60 could be attached to another fluid device in any manner desired.

Referring next to FIGS. 9 to 12, another preferred embodiment of a mechanical tube connection is generally indicated by reference numeral 80. Connection 80 has a male tubular member 12 with an enlarged distal end portion 14 which could accommodate another component, such as a filter. Distal end portion 14 has a lower first portion 81 that contains sealing member groove 16, and a reduced diameter portion 84 located adjacent thereto. An inside annular corner 86 located between first portion 81 and reduced diameter portion 84 forms an annular groove. This inside annular groove or corner 86 forms a circumferential shoulder 88 for retaining female member 82 in place as described below.

Female member 82 is in the form of a cylindrical cup which could be attached to any other fluid device, such as a heat exchanger, and as indicated by chain dotted lines 90.

As seen in FIG. 12, female member 82 is deformed by swaging or squeezing the upper or second portion 33 inwardly against the reduced diameter portion 84 of male member 12. This produces a circumferential or annular shoulder 92 that bears against circumferential shoulder 88 to prevent the male and female components or members 12 and 82 from separating. It will also be noticed that reduced diameter portion 84 of male member 12 is hexagonal in cross-section. When female member 82 is deformed inwardly it also takes on the hexagonal shape. This prevents relative rotation between the male and female members 12, 82 and also provides a secondary seal therebetween which could be enhanced by using a sealant therebetween.

The method of making connections 10, 50, 70 and 80 is much the same in that a male tubular member 12 is provided with an annular sealing member or O-ring 18 located on the exterior thereof, and an outwardly opening annular groove 54 or 86, or an outwardly opening flange 20, spaced from sealing member 18. A female member having a first portion 31 with an inside diameter dimensioned to be in sealing engagement with the sealing member or O-ring 18 provides the primary fluid seal between the male and female members. The second portion 33 of the female member is deformed inwardly, so that a portion of the female member enters the annular groove 54 or 86 or provides a circumferential shoulder 34 or 92, or a flange 62, to engage a similar circumferential shoulder 22, 58 or 88 on the male member, thereby preventing relative axial movement between the male and female members and also providing a secondary seal and preventing relative rotation therebetween, if desired. The female member can be deformed by a staking operation as shown in FIG. 7, or by forming a continuous inwardly disposed groove or depression, thus providing a shoulder or annular flange extending into an annular groove in the male member. Where an annular flange 20 is provided on the male member, the female member tubular wall portion 33 is crimped inwardly to engage the flange thereby preventing relative axial movement between the male and female members. Even where the female member is formed with an inside annular groove 32, the second portion 33 of tubular wall portion 30 that is not engaging O-ring 18 is crimped radially inwardly compressing the second portion 33 of tubular wall portion 30 in the area of annular groove 32.

Referring again to FIGS. 6 and 8, it will be appreciated that the female member 60 can be slid over the male member 12 by sliding the female member first over the sealing member 18, and then over the annular groove 54 as in FIG. 6, or the female member can be slid first over the annular groove 54 and then over the sealing member or O-ring 18, as in FIG. 8.

Having described preferred embodiments, it will be appreciated that various modifications may be made to the structures described above. For example, some of the female members have been shown having an enlarged portion that engages the male member and a reduced diameter portion extending therefrom. However, the female member could be a straight tube, as could the male member, in which case it would not matter in which direction the two members were slid relative to one another to get them into a position to be crimped or swaged together. The male and female members have been described as being tubular. This would include being circular in cross-section, as well as other configurations such as rectangular, triangular or some other shape, as long as a suitable sealing member 18 could be provided to give the required seal Non-circular shapes also would prevent relative rotation between the male and female members, but even with circular cross-sections, flat areas could be provided on the male members to prevent relative rotation, if desired. The male and female members normally are formed of deformable metal, such as aluminum, stainless steel, copper or brass, but they could be formed of some other material, such as a suitable plastic material. The female member could also be formed as an integral part or component of a fluid containing device.

As will be apparent to those skilled in the art in light of the foregoing disclosure, many alterations and modifications are possible in the practice of this invention without departing from the spirit or scope thereof. Accordingly, the scope of the invention is to be construed in accordance with the substance defined by the following claims.

1. A mechanical tube connection comprising:
a male tubular member having a distal end portion defining a circumferential sealing member groove located therein;
an annular sealing member for location in the sealing member groove;
a female member having a female tubular wall portion adapted to accommodate the male tubular member distal end portion with the annular sealing member in sealing engagement therebetween;
one of the male tubular member and the female tubular wall portion having a circumferential shoulder formed therein spaced from the annular sealing member groove, so as not to compress axially the sealing member; and
the other of the male tubular member and the female wall portion having a radially disposed protrusion adapted to bear against the shoulder to prevent separation of the male and female members.

2. A mechanical tube connection as claimed in claim 1 wherein the female tubular wall portion has an axially straight inner wall surface, so that the sealing member is in radial compression only.

3. A mechanical tube connection as claimed in claim 2 wherein said circumferential shoulder is one peripheral side of an annular groove formed on one of the male tubular member and the female tubular wall portion.

4. A mechanical tube connection as claimed in claim 2 wherein said circumferential shoulder is one peripheral side of an annular flange formed on one of the male tubular member and the female tubular wall portion.

5. A mechanical tube connection as claimed in claim 3 wherein the annular groove is formed on the outside surface of the male tubular member.

6. A mechanical tube connection as claimed in claim 3 wherein the annular groove is formed on the inside surface of the female tubular member.

7. A mechanical tube connection as claimed in claim 5 wherein the radially disposed protrusion is an inwardly disposed projection formed in the female tubular wall portion.

8. A mechanical tube connection as claimed in claim 5 wherein the radially disposed protrusion is an inwardly disposed annular flange formed in the female annular wall portion.

9. A mechanical tube connection as claimed in claim 6 wherein the radially disposed protrusion is an outwardly disposed annular flange formed on the male tubular member spaced from the annular sealing member.

10. A mechanical tube connection as claimed in claim 1 wherein the male tubular member has a distal end, the sealing member groove is located adjacent to the distal end, and the circumferential shoulder is located on the side of the annular sealing member groove remote from the distal end.

11. A mechanical tube connection as claimed in claim 1 wherein the male tubular member has a distal end, the circumferential shoulder is located adjacent to the distal end, and the sealing member groove is located on the side of the circumferential shoulder remote from the distal end.

12. A method of making a connection between two telescoping tubular members, comprising:
providing a male tubular member with an annular seal located on the exterior thereof and an annular flange extending radially outwardly and being axially spaced from the annular seal;
sliding a female tubular member over the male member, the female member having a first portion with an inside diameter dimensioned to be in sealing engagement with the sealing member and an adjacent second portion with an inside diameter dimensioned to slide over the male member annular flange; and
compressing the second portion inwardly to engage the flange thereby preventing axial movement between the male and female members.

13. A method as claimed in claim 12 and further comprising the step of forming an inside annular groove in the female member second portion to be located over the annular flange, and wherein the second portion is compressed by radially compressing the second portion in the area of the inside annular groove.

14. A method as claimed in claim 12 wherein the male member has a distal end, the annular seal is located adjacent to the distal end and the annular flange is located on the side of the annular seal remote from the distal end, and wherein the female tubular member is slid over the male member by first sliding the second portion over the male member distal end.

15. A method of making a connection between two telescoping tubular members, comprising:
providing a male tubular member with an annular sealing member located on the exterior thereof and an outwardly opening annular groove spaced from the annular sealing member;
sliding a female tubular member over the male member, the female member having an inside diameter dimensioned to be in sealing engagement with the sealing member; and
inwardly deforming the female member so that a portion of the female member enters the annular groove thereby preventing relative axial movement between the male and female members.

16. A method as claimed in claim 15 wherein the female member is inwardly deformed by staking portions of the female tubular wall at circumferentially spaced apart intervals.

17. A method as claimed in claim 15 wherein the female member is inwardly deformed by swaging an annular groove into the wall of the female tubular member thus forming an inwardly disposed annular flange extending into the male member annular groove.

18. A method as claimed in claim 15, wherein the male member has a first portion containing the sealing member and a reduced diameter portion located adjacent thereto, and wherein the annular groove is in the form of an inside annular corner located between the first and second portions, the female member being deformed by squeezing a portion thereof against the reduced diameter portion of the male member.

19. A method as claimed in claim 15 wherein the female member is slid over the male member by sliding the female member over the sealing member first and then over the annular groove.

20. A method as claimed in claim 15 wherein the female member is slid over the male member by sliding the female member over the annular groove first and then over the sealing member.
